(19) United States
(12) Patent Application Publication
(10) Pub. No.: US 2022/0319086 A1
(43) Pub. Date: Oct. 6, 2022

(54) METHOD AND APPARATUS FOR CONTROLLING ANIMATION REFRESHING, COMPUTER DEVICE, AND STORAGE MEDIUM

(71) Applicant: ONEPLUS TECHNOLOGY (SHENZHEN) CO., LTD., Shenzhen (CN)

(72) Inventor: Zhanjun MENG, Shenzhen (CN)

(21) Appl. No.: 17/843,214

(22) Filed: Jun. 17, 2022

Related U.S. Application Data
(63) Continuation of application No. PCT/CN2020/135645, filed on Dec. 11, 2020.

(30) Foreign Application Priority Data
Dec. 19, 2019 (CN) 201911314775.5

(51) Int. Cl. G06T 13/00; G06T 1/20

(52) U.S. Cl. CPC G06T 13/00; G06T 1/20

(57) ABSTRACT

A method for controlling animation refreshing, a computer device, and a storage medium are provided. The method includes the following. An animation-refreshing request of an animation is received, where the animation-refreshing request instructs a processor to perform animation refreshing corresponding to the animation-refreshing request. In response to a current time reaching a preset refreshing time, at least one target animation-refreshing request in a time period from the current time to a last refreshing time is obtained from at least one received animation-refreshing request. The at least one target animation-refreshing request is sent to the processor.

### CROSS-REFERENCE TO RELATED APPLICATION(S)

This application is a continuation of International Application No. PCT/CN2020/135645, filed Dec. 11, 2020, which claims priority to Chinese Patent Application No. 201911314775.5, filed Dec. 19, 2019, the entire disclosures of which are incorporated herein by reference.

### TECHNICAL FIELD

This disclosure relates to the field of computer technology, and in particular to a method for controlling animation refreshing, a computer device, and a storage medium.

### BACKGROUND

With the development of computer technology, service demands of users for terminal applications are increasing. Requirements for smoothness of animation display in an application interface and granularity of screen display elements are also getting higher and higher, requiring continuous animation or simultaneous movement of multiple objects. At present, when an animation is displayed on a page, continuous actions of the animation is realized by triggering a processor to perform animation refreshing.

However, in a traditional mechanism, each animation handles refreshing of its own interface. Rendering continuous and complex animations in one interface will cause frequent use of the processor and fast power consumption.

### SUMMARY

In a first aspect, a method for controlling animation refreshing includes the following. An animation-refreshing request of an animation is received, where the animation-refreshing request instructs a processor to perform animation refreshing corresponding to the animation-refreshing request. In response to a current time reaching a preset refreshing time, at least one target animation-refreshing request in a time period from the current time to a last refreshing time is obtained from at least one received animation-refreshing request. The at least one target animation-refreshing request is sent to the processor, to cause the processor to perform animation refreshing corresponding to the at least one target animation-refreshing request.

In a second aspect, a computer device includes a memory and at least one processor. The at least one processor includes a first processor and a second processor. The memory stores a computer program which is executed by the first processor to cause the first processor to implement the method of the first aspect.

In a third aspect, a non-transitory computer-readable storage medium stores a computer program which is executed by a processor to cause the processor to implement the method of the first aspect.

### BRIEF DESCRIPTION OF THE DRAWINGS

FIG. 1 is schematic diagram of an internal structure of a computer device in implementations of the disclosure.

FIG. 2 is a schematic flowchart of a method for controlling animation refreshing in implementations of the disclosure.

FIG. 3 is a schematic flowchart of blocks for animation refreshing in implementations of the disclosure.

FIG. 4 is a schematic flowchart of a method for controlling animation refreshing in implementations of the disclosure.

FIG. 5 is a structural block diagram of an apparatus for controlling animation refreshing in implementations of the disclosure.

FIG. 6 is a structural block diagram of an apparatus for controlling animation refreshing in implementations of the disclosure.

### DETAILED DESCRIPTION

In order to make the purpose, technical solutions and advantages of the present application more clearly understood, the present application will be described in further detail below with reference to accompanying drawings and implementations. It should be understood that the specific implementations described herein are only used to explain but not to limit the present application.

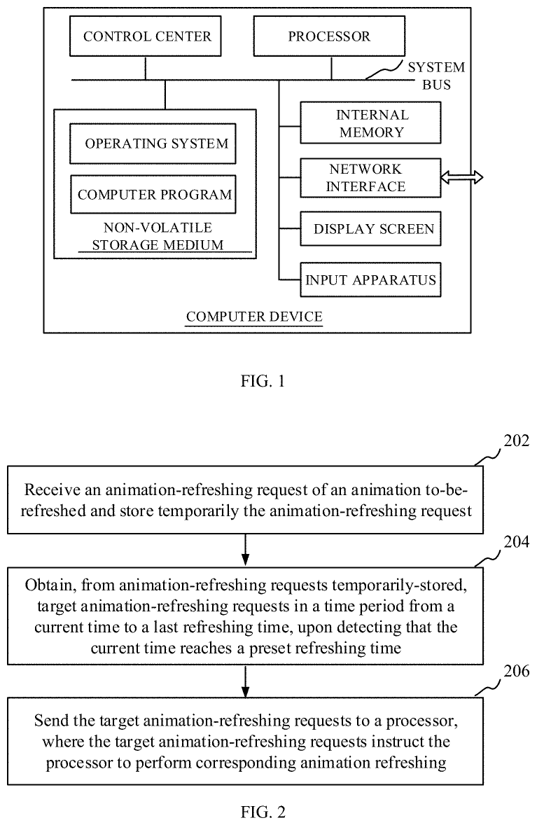

A method for controlling animation refreshing provided in the disclosure may be applied to a computer device. The computer device may be a terminal, and an internal structure of the computer device may be as illustrated in FIG. 1. The computer device includes a processor, a memory, a network interface, a display screen, and an input apparatus coupled through a system bus.

A control center receives an animation-refreshing request of an animation to-be-refreshed and stores temporarily the animation-refreshing request; obtains, from animation-refreshing requests temporarily-stored, target animation-refreshing requests in a time period from a current time to a last refreshing time, upon detecting that the current time reaches a preset refreshing time; and sends the target animation-refreshing requests to a processor, where the target animation-refreshing requests instruct the processor to perform corresponding animation refreshing. The processor of the computer device is configured to provide computing and control capabilities. The memory of the computer device includes a non-volatile storage medium and an internal memory. The non-volatile storage medium stores an operating system and a computer program. The internal memory provides an environment for execution of the operating system and the computer program in the non-volatile storage medium. The network interface of the computer device is configured to communicate with an external terminal through a network connection. When the computer program is executed by the processor, the method for controlling animation refreshing is implemented. The display screen of the computer device may be a liquid crystal display screen or an electronic ink display screen, and the input apparatus of the computer device may be a touch layer covered on the display screen, or a button, a trackball or a touchpad set on the shell of the computer device, or an external keyboard, touchpad, or mouse.

Those skilled in the art can understand that the structure illustrated in FIG. 1 is only a block diagram of a partial structure related to the solution of the present application, and does not constitute a limitation on the computer device to which the solution of the present application is applied. The specific computer device may include more or fewer components than illustrated in FIG. 1, or combine certain components, or have a different arrangement of components.

In implementations of the disclosure, a method for controlling animation refreshing includes the following. An animation-refreshing request of an animation is received, where the animation-refreshing request instructs a processor to perform animation refreshing corresponding to the animation-refreshing request. In response to a current time reaching a preset refreshing time, at least one target animation-refreshing request in a time period from the current time to a last refreshing time is obtained from at least one received animation-refreshing request. The at least one target animation-refreshing request is sent to the processor, to cause the processor to perform animation refreshing corresponding to the at least one target animation-refreshing request.

In an implementation, as illustrated in FIG. 2, a method for controlling animation refreshing is provided. The method is exemplarily applied to the terminal in FIG. 1. The method begins at block 202.

At block 202, an animation-refreshing request of an animation to-be-refreshed is received and the animation-refreshing request is stored temporarily.

An animation is realized by a sequence of images. The animation may be moving images formed by shooting an object frame by frame to obtain a sequence of images and continuously playing this sequence of images. There may be many types of animation, including but not limited to two-dimensional animation, three-dimensional animation, and the like. Animation refreshing refers to a process of processing images required for animation playback to realize animation playback. For example, animation refreshing may be video playback, which is realized by loading, rendering, displaying, and other processing of images required for the video. The animation-refreshing request is used to refresh a frame of the animation currently displayed. One animation may include multiple sub-animations, and refreshing of one animation requires refreshing of respective sub-animations. Each sub-animation may have a different image size and different refreshing time. For example, one animation includes changes of action, expression, etc. of different characters, and the change of action or expression of each character corresponds to different frame data.

Specifically, the control center of the terminal receives an animation-refreshing request(s) of each sub-animation in the animation to-be-refreshed, where each animation-refreshing request carries a request time of the refreshing request. The received animation-refreshing requests are stored in the control center in order of request time. Optionally, the terminal receives the animation-refreshing request of the animation to-be-refreshed and temporarily stores the received animation-refreshing request in a cache of the terminal. A caching method may include but is not limited to memory caching, file caching, database caching, Memcache caching, etc.

At block 204, upon detecting that a current time reaches a preset refreshing time, a target animation-refreshing request(s) in a time period from the current time to a last refreshing time is obtained from an animation-refreshing request(s) temporarily-stored.

The preset refreshing time refers to an animation-refreshing time set in advance. In animation refreshing, preset refreshing times may be at equal or unequal time intervals. For example, in animation refreshing, the preset refreshing times may be every 60 ms (milliseconds), or may be at time intervals of 10 ms, 20 ms, 40 ms, and 60 ms sequentially. The setting of the preset refreshing times is not limited herein.

Specifically, when the terminal receives the animation-refreshing request of the animation to-be-refreshed, the terminal obtains the current time in real time by invoking a time function. A data type of the obtained current time may be a string type. When the obtained current time is the same as the preset refreshing time, the last refreshing time is obtained. According to the last refreshing time and the current time, the target animation-refreshing requests in the time period from the current time to the last refreshing time are obtained from the cache. The target animation-refreshing request(s) may be all animation-refreshing requests in the time period from the current time to the last refreshing time that are stored in the cache. For example, in a case that the last refreshing time is 9:30:00 and the current refreshing time is 9:30:30, all target animation-refreshing requests corresponding to the time period from 9:30:00 to 9:30:30 are obtained from the animation-refreshing requests temporarily-stored.

In an implementation, when the animation starts playing, the terminal receives the animation-refreshing request of the animation to-be-refreshed and trigger start of a timer. When a timing duration of the timer equals to a preset time interval, that is, when the current time reaches the preset refreshing time, the terminal obtains the last refreshing time and obtains the target animation-refreshing requests in the time period from the current time to the last refreshing time from the cache.

At block 206, the target animation-refreshing request(s) is sent to a processor, where the target animation-refreshing request(s) instructs the processor to perform corresponding animation refreshing.

Specifically, when the current time reaches the preset refreshing time, the control center of the terminal sends a wake-up instruction to the processor to wake up the processor from an idle state. In a wake-up state, the processor receives the target animation-refreshing requests and then performs animation refreshing corresponding to the target animation-refreshing requests. The wake-up instruction may be, but is not limited to, a current pulse signal, which includes a rising edge pulse signal or a falling edge pulse signal.

According to the method for controlling animation refreshing, the animation-refreshing request of the animation to-be-refreshed is received and the animation-refreshing request is stored temporarily. Upon detecting that the current time reaches the preset refreshing time, the target animation-refreshing requests in the time period from the current time to the last refreshing time are obtained from the animation-refreshing requests temporarily-stored. The target animation-refreshing requests are sent to the processor, where the target animation-refreshing requests instruct the processor to perform corresponding animation refreshing. Instead of sending an animation-refreshing request to the processor immediately upon receiving the animation-refreshing request so as to complete corresponding animation refreshing, target animation-refreshing requests in the time period are obtained from the animation-refreshing requests temporarily-stored and sent to the processor only when the preset refreshing time is reached, so as to complete corresponding animation refreshing. By reducing wake-up times of the processor, the working time of the processor executing animation refreshing can be reduced, thereby reducing power loss and power consumption of the processor.

In an implementation, after the target animation-refreshing requests are sent to the processor, the target animation-refreshing requests are removed from the animation-refreshing requests temporarily-stored.

Specifically, after the terminal sends the target animation-refreshing requests to the processor, the terminal deletes the target animation-refreshing requests from the cache, so as to avoid data loss of animation-refreshing requests due to insufficient storage space that may cause unsmooth animation playback and influence animation effect. In addition, efficiency of reading the target animation-refreshing requests from the cache can be improved.

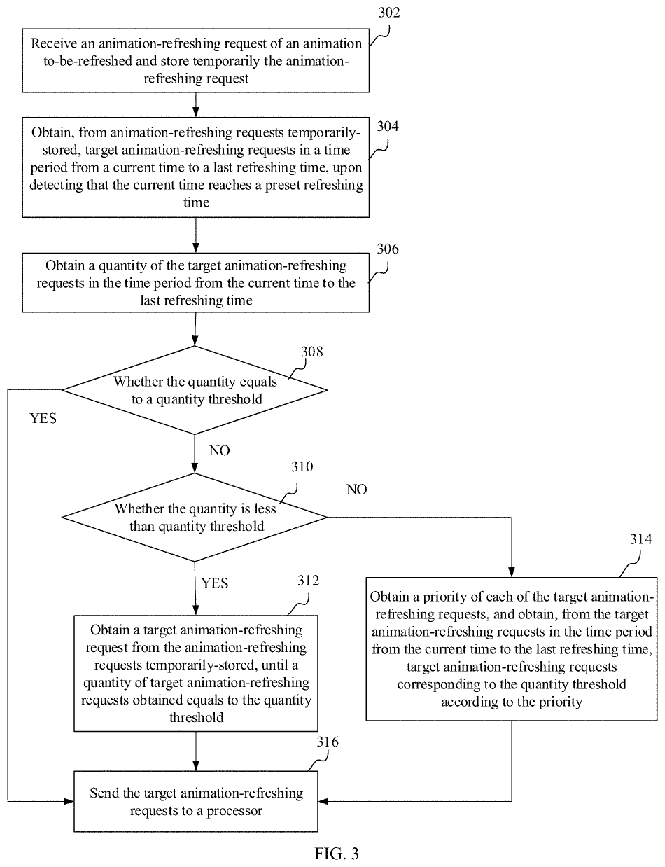

In an implementation, as illustrated in FIG. 3, a method for controlling animation refreshing is provided. The method is exemplarily applied to the terminal in FIG. 1. The method begins at block 302.

At block 302, an animation-refreshing request of an animation to-be-refreshed is received and the animation-refreshing request is stored temporarily.

At block 304, upon detecting that a current time reaches a preset refreshing time, target animation-refreshing requests in a time period from the current time to a last refreshing time are obtained from animation-refreshing requests temporarily-stored.

At block 306, a quantity of the target animation-refreshing requests in the time period from the current time to the last refreshing time is determined.

Specifically, the terminal may determine the quantity of the target animation-refreshing requests in the time period from the current time to the last refreshing time according to, but not limited to, a result returned by an invoked count function. For example, the count function may be count( ).

At block 308, whether the quantity equals to a quantity threshold is determined. If the quantity equals to the quantity threshold, proceed to block 316. If the quantity does not equal to the quantity threshold, proceed to block 310.

The quantity threshold is a preset quantity. The preset quantity is set to ensure best operation performance of the processor and a smooth animation refreshing effect.

At block 310, whether the quantity is less than the quantity threshold is determined. If the quantity is less than the quantity threshold, proceed to block 312. If the quantity is not less than the quantity threshold, proceed to block 314.

At block 312, obtain a target animation-refreshing request from the animation-refreshing requests temporarily-stored, until a quantity of target animation-refreshing requests obtained equals to the quantity threshold.

Specifically, when the current time reaches the preset refreshing time, if the quantity of the target animation-refreshing requests in the time period from the current time to the last refreshing time is less than the quantity threshold, the terminal will not send the target animation-refreshing requests to the processor. Instead, the preset refreshing time is postponed until a quantity of target animation-refreshing requests in a time period from the postponed preset refreshing time to the last refreshing time equals to the quantity threshold, and then proceed to step 316.

At block 314, a priority of each of the target animation-refreshing requests is obtained, and target animation-refreshing requests of the quantity threshold are obtained from the target animation-refreshing requests in the time period from the current time to the last refreshing time according to the priority.

Priority represents an order of selecting a target animation-refreshing request to send to the processor. For example, the target animation-refreshing request with the highest priority will be sent to the processor first. The priority can be represented by but not limited to a number. For example, a processing order corresponding to priority 1, priority 2, and priority 3 may be: priority 1>priority 2>priority 3.

Specifically, upon detecting that the current time reaches the preset refreshing time, if the quantity of the target animation-refreshing requests in the time period from the current time to the last refreshing time is greater than the quantity threshold, the priority of each of the target animation-refreshing requests is obtained, and target animation-refreshing requests of the quantity threshold are obtained from the target animation-refreshing requests in the time period from the current time to the last refreshing time according to the priority. For example, the quantity threshold is 2, and the target animation-refreshing requests are target animation-refreshing request A, target animation-refreshing request B, and target animation-refreshing request C, where a priority corresponding to target animation-refreshing request A is 1, a priority corresponding to target animation-refreshing request B is 2, and a priority corresponding to target animation-refreshing request C is 3. If priority 1>priority 2>priority 3, the target animation-refreshing requests obtained according to the priorities are target animation-refreshing request A and target animation-refreshing request B.

In an implementation, if the quantity is greater than the quantity threshold, the preset refreshing time is updated to an updated preset refreshing time. Upon detecting that the current time reaches the updated preset refreshing time and the quantity of target animation-refreshing requests in the time period from the current time to the last refreshing time equals to the quantity threshold, the target animation-refreshing requests are sent to the processor.

Specifically, if it is detected multiple times that the quantity of target animation-refreshing requests in the time period from the current time to the last refreshing time obtained from the cache is greater than the quantity threshold when the current time reaches the preset refreshing time, the preset refreshing time is updated, that is, a time interval between two adjacent refreshing times is shortened. Upon detecting that the current time reaches the updated preset refreshing time and the quantity of target animation-refreshing requests in the time period from the current time to the last refreshing time obtained from the cache equals to the quantity threshold, the target animation-refreshing requests are sent to the processor. In this way, performance degradation of the processor due to reception of excessive number of target animation refreshing requests by the processor can be avoided, and the animation can be smoothly refreshed.

At block 316, the target animation-refreshing requests are sent to the processor.

Specifically, the terminal sends the target animation-refreshing requests to the processor, and the processor performs corresponding animation refreshing according to the target animation-refreshing requests, so as to achieve continuous playback of the animation.

In the above operations for controlling animation refreshing, the animation-refreshing request of the animation to-be-refreshed is received and the animation-refreshing request is stored temporarily. Upon detecting that the current time reaches the preset refreshing time, target animation-refreshing requests in the time period from the current time to the last refreshing time are obtained from the animation-refreshing requests temporarily-stored. The quantity of the target animation-refreshing requests in the time period from the current time to the last refreshing time is obtained. Whether the quantity equals to the quantity threshold is determined. If the quantity equals to the quantity threshold, the target animation-refreshing requests are sent to the processor. If the quantity is less than the quantity threshold, continue to obtain a target animation-refreshing request from the animation-refreshing requests temporarily-stored, until the quantity of target animation-refreshing requests obtained equals to the quantity threshold, and then the target animation-refreshing requests obtained are sent to the processor. If the quantity is greater than the quantity threshold, the priority of each of the target animation-refreshing requests is obtained. Target animation-refreshing requests of the quantity threshold are obtained from target animation-refreshing requests in the time period from the current time to the last refreshing time according to the priority, and then the target animation-refreshing requests are sent to the processor. By determining the quantity of target animation-refreshing requests in the time period from the current time to the last refreshing time when the current time reaches the preset refreshing time, it can be ensured that the processor receives the target animation-refreshing requests of the quantity threshold, which can not only reduce the working time and power consumption of the processor, but also ensure operation performance of the processor and an animation effect of animation refreshing.

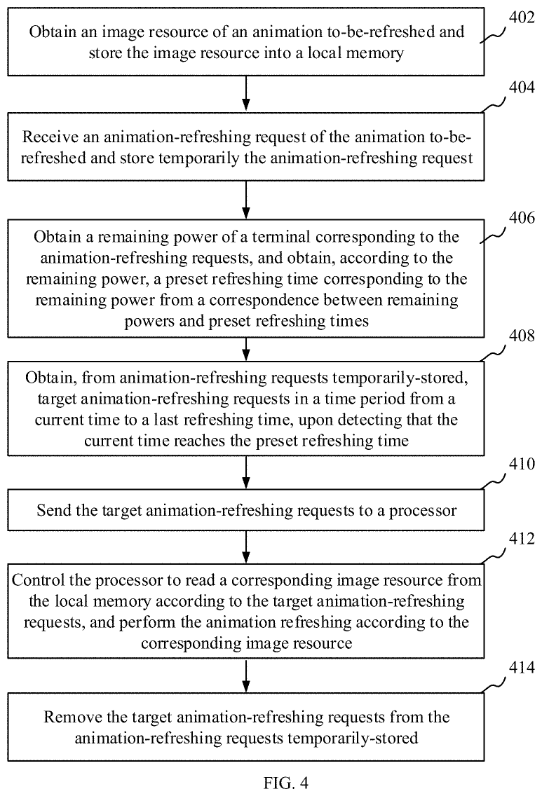

In another implementation, as illustrated in FIG. 4, a method for controlling animation refreshing is provided. The method is exemplarily applied to the terminal in FIG. 1. The method begins at block 402.

At block 402, an image resource of an animation to-be-refreshed is obtained and the image resource is stored into a local memory.

Specifically, the terminal may, but is not limited to, download the image resource of the animation to-be-refreshed from a server, and render the obtained image resource through a graphics processing unit (GPU) to obtain rendered data. The rendered data is then stored into the local memory.

At block 404, an animation-refreshing request of the animation to-be-refreshed is received and the animation-refreshing request is stored temporarily.

Specifically, the terminal receives the animation-refreshing request of the animation to-be-refreshed and stores temporarily the received animation-refreshing request into a cache of the terminal.

At block 406, a remaining power of the terminal including the processor is obtained, and a preset refreshing time corresponding to the remaining power is obtained from a correspondence between remaining powers and preset refreshing times according to the remaining power.

Specifically, the control center obtains the remaining power of the terminal including the processor (that is, the terminal executing the animation refreshing) and obtains a time interval corresponding to an adjacent preset refreshing time according to the remaining power. The control center obtains the current time and reset a preset refreshing time according to the current time and the time interval. For example, if the remaining power is within a range of 80%-85%, the time interval corresponding to the adjacent preset refreshing time is 20 ms, and if the remaining power is within a range of 80%-85%, the time interval corresponding to the adjacent preset refreshing time is 30 ms. If the remaining power obtained is changed from 84% to 82%, the time interval corresponding to the adjacent preset refreshing time is changed from 20 ms to 30 ms. In a case that the current time is 10:12:01.00, the preset refreshing time is changed from 10:12:01.20 to 10:12:01.30.

At block 408, upon detecting that the current time reaches the preset refreshing time, target animation-refreshing requests in a time period from a current time to a last refreshing time are obtained from animation-refreshing requests temporarily-stored.

At block 410, the target animation-refreshing requests are sent to the processor.

Specifically, the terminal sends a wake-up instruction to the processor to wake up the processor from an idle state. In a wake-up state, the processor receives the target animation-refreshing requests and then performs animation refreshing corresponding to the target animation-refreshing requests.

At block 412, the processor is controlled to read a corresponding image resource from the local memory according to the target animation-refreshing requests, and perform the animation refreshing according to the corresponding image resource.

Specifically, the terminal controls the processor to read corresponding render data from the local memory according to the target animation-refreshing requests and display the render data on a display screen corresponding to the terminal, so as to complete animation refreshing.

At block 414, the target animation-refreshing requests are removed from the animation-refreshing requests temporarily-stored.

Specifically, when the terminal detects that the processor completes corresponding animation refreshing according to the target animation-refreshing requests, the terminal deletes the target animation-refreshing requests from the cache.

In this method for controlling animation refreshing, before receiving and storing temporarily the animation-refreshing request of the animation to-be-refreshed into the cache, the image resource of the animation to-be-refreshed is first obtained from the server and stored into the local memory. The remaining power of the terminal including the processor is then obtained. According to the remaining power, the preset refreshing time corresponding to the remaining power is obtained from the correspondence between remaining powers and preset refreshing times, and the preset refreshing time is changed according to the current remaining power of the terminal. Upon detecting that the current time reaches the preset refreshing time, target animation-refreshing requests in the time period from the current time to the last refreshing time are obtained from animation-refreshing requests temporarily-stored. The target animation-refreshing requests are sent to the processor. The processor is controlled to read the corresponding image resource from the local memory according to the target animation-refreshing requests, and perform the animation refreshing according to the corresponding image resource. When the terminal detects that the processor completes corresponding animation refreshing according to the target animation-refreshing requests, the target animation-refreshing requests are deleted from the cache. By reducing the number of times to wake up the processor, the working time of the processor executing animation refreshing can be reduced, and the power loss and power consumption of the processor can be reduced. By determining the corresponding preset refreshing time according to the remaining power of the terminal, stability of animation refreshing effect can be improved.

In an implementation, the terminal receives an image resource of an animation to-be-refreshed and stored the image resource into a local memory. The terminal receives an animation-refreshing request of the animation to-be-refreshed and stores temporarily the animation-refreshing request into a cache. The terminal obtains a remaining power of the terminal, and obtains a preset refreshing time corresponding to the remaining power from a correspondence between remaining powers and preset refreshing times according to the remaining power. Upon detecting that a current time reaches the preset refreshing time, the terminal obtains target animation-refreshing requests in a time period from the current time to a last refreshing time from animation-refreshing requests temporarily-stored. The terminal obtains a quantity of the target animation-refreshing requests in the time period from the current time to the last refreshing time.

Whether the quantity equals to a quantity threshold is determined. If the quantity equals to the quantity threshold, the target animation-refreshing requests are sent to a processor, and the processor performs corresponding animation refreshing according to the target animation-refreshing requests. Upon a detection that the processor completes corresponding animation refreshing, the terminal deletes the target animation-refreshing requests from the cache. If the quantity is less than the quantity threshold, the terminal continues to obtain a target animation-refreshing request from the animation-refreshing requests temporarily-stored, until a quantity of target animation-refreshing requests obtained equals to the quantity threshold, and then sends the target animation-refreshing requests to the processor. The processor performs corresponding animation refreshing according to the target animation-refreshing requests. Upon a detection that the processor completes corresponding animation refreshing, the terminal deletes the target animation-refreshing requests from the cache. If the quantity is greater than the quantity threshold, the preset refreshing time is updated to an updated preset refreshing time. When the current time reaches the updated preset refreshing time and a quantity of target animation-refreshing requests in a time period from the current time to the last refreshing time equals to the quantity threshold, the target animation-refreshing requests are sent to the processor. The processor performs corresponding animation refreshing according to the target animation-refreshing requests. Upon a detection that the processor completes corresponding animation refreshing, the terminal deletes the target animation-refreshing requests from the cache.

It should be understood that although blocks in the flowcharts of FIGS. 2-4 are illustrated in sequence according to the arrows, these blocks are not necessarily executed in the sequence illustrated by the arrows. Unless explicitly stated herein, the execution of these blocks is not strictly limited to the order, and these blocks may be performed in other orders. Moreover, at least a part of the blocks in FIGS. 2-4 may include multiple sub-blocks or multiple stages. These sub-blocks or stages are not necessarily executed and completed at the same time, but may be executed at different times. The blocks are not necessarily executed sequentially, but may be performed in turn or alternately with other blocks or at least a part of sub-blocks or stages of other blocks.

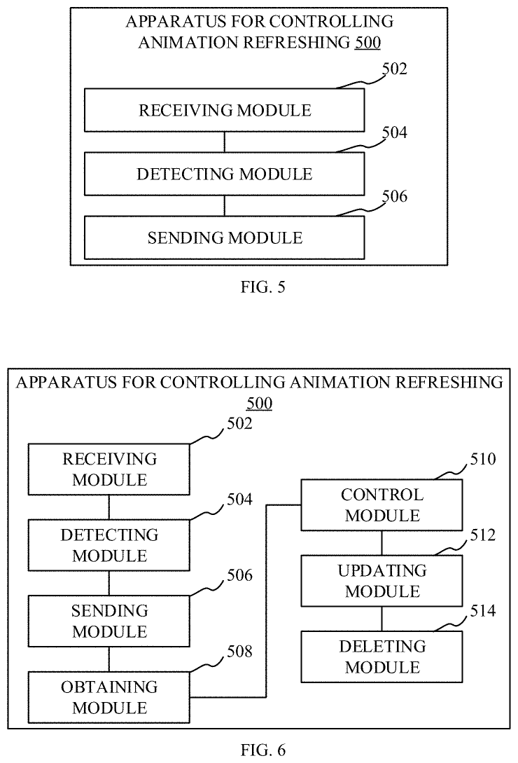

In an implementation, as illustrated in FIG. 5, an apparatus 500 for controlling animation refreshing is provided. The apparatus 500 includes a receiving module 502, a detecting module 504, and a sending module 506.

The receiving module 502 is configured to receive an animation-refreshing request of an animation to-be-refreshed and store temporarily the animation-refreshing request.

The detecting module 504 is configured to obtain, from an animation-refreshing request(s) temporarily-stored, a target animation-refreshing request(s) in a time period from a current time to a last refreshing time, upon detecting that the current time reaches a preset refreshing time.

The sending module 506 is configured to send the target animation-refreshing requests to a processor, where the target animation-refreshing requests instruct the processor to perform corresponding animation refreshing.

According to the apparatus for controlling animation refreshing, the animation-refreshing request of the animation to-be-refreshed is received and the animation-refreshing request is stored temporarily. Upon detecting that the current time reaches the preset refreshing time, target animation-refreshing requests in the time period from the current time to the last refreshing time are obtained from animation-refreshing requests temporarily-stored. The target animation-refreshing requests are sent to the processor, where the target animation-refreshing requests instruct the processor to perform corresponding animation refreshing. By reducing the number of times of sending the animation-refreshing requests to the processor and reducing the working time of the processor executing animation refreshing, power loss and power consumption of the processor can be reduced.

In another implementation, as illustrated in FIG. 6, the apparatus 500 for controlling animation refreshing is provided. In addition to the receiving module 502, the detecting module 504, and the sending module 506, the apparatus 500 further includes an obtaining module 508, a control module 510, an updating module 512, and a deleting module 514.

The obtaining module 508 is configured to obtain an image resource of the animation to-be-refreshed and store the image resource into a local memory.

In an implementation, the obtaining module 508 is further configured to obtain a quantity of the target animation-refreshing requests in the time period from the current time to the last refreshing time.

In an implementation, the obtaining module 508 is further configured to continue to obtain a target animation-refreshing request from the animation-refreshing requests temporarily-stored upon detecting that the quantity is less than a quantity threshold, until a quantity of target animation-refreshing requests obtained equals to the quantity threshold.

In an implementation, the obtaining module 508 is further configured to obtain a priority of each of the target animation-refreshing requests upon detecting that the quantity is greater than the quantity threshold, and obtain, from the target animation-refreshing requests in the time period from the current time to the last refreshing time, target animation-refreshing requests of the quantity threshold according to the priority.

In an implementation, the obtaining module 508 is further configured to detect that the current time reaches an updated preset refreshing time and a quantity of the target animation-refreshing requests in a time period from the current time to the last refreshing time obtained from the animation-refreshing requests temporarily-stored equals to the quantity threshold.

In an implementation, the obtaining module 508 is further configured to obtain a remaining power of the terminal including the processor, and obtain, according to the remaining power, the preset refreshing time corresponding to the remaining power from a correspondence between remaining powers and preset refreshing times.

The control module 510 is configured to control the processor to read a corresponding image resource from the local memory according to the target animation-refreshing requests, and perform the animation refreshing according to the corresponding image resource.

The updating module 512 is configured to update the preset refreshing time to the updated preset refreshing time, upon detecting that the quantity is greater than the quantity threshold.

The deleting module 514 is configured to delete the target animation-refreshing requests from the cache.

In an implementation, before the receiving module 502 receives the animation-refreshing request of the animation to-be-refreshed and stores temporarily the animation-refreshing request, the obtaining module 508 first obtains the image resource of the animation to-be-refreshed and stores the image resource into the local memory. Then the obtaining module 508 obtains the remaining power of the terminal executing the animation refreshing, and obtains, according to the remaining power, the preset refreshing time corresponding to the remaining power from the correspondence between remaining powers and preset refreshing times and changes the preset refreshing time according to the current remaining power of the terminal. When the detecting module 504 detects that the current time reaches the preset refreshing time, target animation-refreshing requests in the time period from the current time to the last refreshing time are obtained from animation-refreshing requests temporarily-stored. The target animation-refreshing requests are sent to the processor via the sending module 506. The processor is controlled via the control module 510 to read the corresponding image resource from the local memory according to the target animation-refreshing requests, and perform the animation refreshing according to the corresponding image resource. After the processor completes animation refreshing according to the image resource, the target animation-refreshing requests are removed via the deleting module 514 from the animation-refreshing requests temporarily-stored.

For the specific limitation of the apparatus for controlling animation refreshing, reference may be made to the limitation of the method for controlling animation refreshing above, which will not be repeated herein. Each module in the above apparatus for controlling animation refreshing may be implemented in whole or in part by software, hardware, or a combination thereof. The above modules can be embedded in or independent of the processor in the computer device in the form of hardware, or stored in the memory in the computer device in the form of software, so that the processor can invoke the software to execute the operations corresponding to the above modules.

In an implementation, a computer device is provided. The computer device include a memory and at least one processor. The at least one processor includes a first processor and a second processor, where the first processor and the second processor may be the same or different processors, or the first processor can be integrated with the second processor. The memory stores a computer program which, when executed by the first processor, implements method of any of implementations of the disclosure.

In an implementation, the computer program which, when executed by the first processor, implements the following operations.

An animation-refreshing request of an animation to-be-refreshed is received and the animation-refreshing request is stored temporarily. Upon detecting that the current time reaches a preset refreshing time, target animation-refreshing requests in a time period from a current time to a last refreshing time are obtained from animation-refreshing requests temporarily-stored. The target animation-refreshing requests are sent to the second processor, where the target animation-refreshing requests instruct the second processor to perform corresponding animation refreshing.

In an implementation, the first processor further executes the computer programs to implement the following operations. Prior to receiving the animation-refreshing request of the animation to-be-refreshed, an image resource of the animation to-be-refreshed is obtained and stored into a local memory. The second processor is controlled to read a corresponding image resource from the local memory according to the target animation-refreshing requests, and perform the animation refreshing according to the corresponding image resource.

In an implementation, the first processor further executes the computer programs to implement the following operations. A quantity of the target animation-refreshing requests in the time period from the current time to the last refreshing time is obtained. Continue to obtain a target animation-refreshing request from the animation-refreshing requests temporarily-stored upon detecting that the quantity is less than a quantity threshold, until a quantity of target animation-refreshing requests obtained equals to the quantity threshold, and proceed to sending the target animation-refreshing requests to the second processor.

In an implementation, the first processor further executes the computer programs to implement the following operations. A quantity of the target animation-refreshing requests in the time period from the current time to the last refreshing time is obtained. A priority of each of the target animation-refreshing requests is obtained upon detecting that the quantity is greater than a quantity threshold. Target animation-refreshing requests of the quantity threshold are obtained from the target animation-refreshing requests in the time period from the current time to the last refreshing time according to the priority. Proceed to sending the target animation-refreshing requests of the quantity threshold to the second processor.

In an implementation, the first processor further executes the computer programs to implement the following operations. A quantity of the target animation-refreshing requests in the time period from the current time to the last refreshing time is obtained. The preset refreshing time is updated to an updated preset refreshing time, upon detecting that the quantity is greater than a quantity threshold. Proceed to sending target animation-refreshing request to the second processor upon detecting that the current time reaches the updated preset refreshing time and a quantity of the target animation-refreshing requests in a time period from the current time to the last refreshing time obtained from the animation-refreshing requests temporarily-stored equals to the quantity threshold.

In an implementation, the first processor further executes the computer programs to implement the following operations. Prior to obtaining, from the animation-refreshing requests temporarily-stored, the target animation-refreshing requests in the time period from the current time to the last refreshing time, upon detecting that the current time reaches the preset refreshing time, a remaining power of a terminal executing the animation refreshing is obtained; and according to the remaining power, the preset refreshing time corresponding to the remaining power is obtained from a correspondence between remaining powers and preset refreshing times.

In an implementation, the first processor further executes the computer programs to implement the following operations. The target animation-refreshing requests are removed from the animation-refreshing requests temporarily-stored.

In an implementation, a computer-readable storage medium is provided. A computer program is stored on the computer-readable storage medium. When executed by a processor, the computer program implements the method of any of implementations of the disclosure.

In an implementation, when executed by a processor, the computer program implements the following operations.

An animation-refreshing request of an animation to-be-refreshed is received and the animation-refreshing request is stored temporarily. Upon detecting that the current time reaches a preset refreshing time, target animation-refreshing requests in a time period from a current time to a last refreshing time are obtained from animation-refreshing requests temporarily-stored. The target animation-refreshing requests are sent to a processor, where the target animation-refreshing requests instruct the processor to perform corresponding animation refreshing.

In an implementation, the processor further executes the computer programs to implement the following operations. Prior to receiving the animation-refreshing request of the animation to-be-refreshed, the method further includes obtaining an image resource of the animation to-be-refreshed and storing the image resource into a local memory. The method further includes controlling the processor to read a corresponding image resource from the local memory according to the target animation-refreshing requests, and perform the animation refreshing according to the corresponding image resource.

In an implementation, the processor further executes the computer programs to implement the following operations. A quantity of the target animation-refreshing requests in the time period from the current time to the last refreshing time is obtained. Continue to obtain a target animation-refreshing request from the animation-refreshing requests temporarily-stored upon detecting that the quantity is less than a quantity threshold, until a quantity of target animation-refreshing requests obtained equals to the quantity threshold, and proceed to sending the target animation-refreshing requests to the processor.

In an implementation, the processor further executes the computer programs to implement the following operations. A quantity of the target animation-refreshing requests in the time period from the current time to the last refreshing time is obtained. A priority of each of the target animation-refreshing requests is obtained upon detecting that the quantity is greater than a quantity threshold. Target animation-refreshing requests of the quantity threshold are obtained from the target animation-refreshing requests in the time period from the current time to the last refreshing time according to the priority. Proceed to sending the target animation-refreshing requests of the quantity threshold to the processor.

In an implementation, the processor further executes the computer programs to implement the following operations. A quantity of the target animation-refreshing requests in the time period from the current time to the last refreshing time is obtained. The preset refreshing time is updated to an updated preset refreshing time, upon detecting that the quantity is greater than a quantity threshold. Proceed to sending target animation-refreshing request to the processor upon detecting that the current time reaches the updated preset refreshing time and a quantity of the target animation-refreshing requests in a time period from the current time to the last refreshing time obtained from the animation-refreshing requests temporarily-stored equals to the quantity threshold.

In an implementation, the processor further executes the computer programs to implement the following operations. Prior to obtaining, from the animation-refreshing requests temporarily-stored, the target animation-refreshing requests in the time period from the current time to the last refreshing time, upon detecting that the current time reaches the preset refreshing time, the method further includes: obtaining a remaining power of a terminal executing the animation refreshing; and obtaining, according to the remaining power, the preset refreshing time corresponding to the remaining power from a correspondence between remaining powers and preset refreshing times.

In an implementation, the processor further executes the computer programs to implement the following operations. The target animation-refreshing requests are removed from the animation-refreshing requests temporarily-stored.

Those of ordinary skill in the art can understand that all or part of the processes in the methods of the above implementations can be implemented by instructing relevant hardware through a computer program, and the computer program can be stored in a non-transitory computer-readable storage medium. When the computer program is executed, the processes of the above-mentioned method implementations may be involved. Any reference to memory, storage, database, or other medium used in the various implementations provided in this application may include non-volatile and/or volatile memory. Non-volatile memory may include read-only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in various forms such as static RAM (SRAM), dynamic RAM (DRAM), synchronous DRAM (SDRAM), double data rate SDRAM (DDRSDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM) and so on.

The technical features of the above implementations can be combined arbitrarily. For the sake of brevity, not all possible combinations of the technical features in the above implementations are described. However, as long as there is no contradiction in the combination of these technical features, it should be considered to be the range described in this specification.

The above-mentioned implementations only represent several implementations of the present application, and the descriptions thereof are specific and detailed, but should not be construed as a limitation on the scope of the invention. It should be pointed out that for those skilled in the art, without departing from the concept of the present application, several modifications and improvements can be made, which all belong to the protection scope of the present application. Therefore, the scope of protection of the patent of the present application shall be subject to the appended claims.

What is claimed is:

1. A method for controlling animation refreshing, comprising:
receiving an animation-refreshing request of an animation, the animation-refreshing request instructing a processor to perform animation refreshing corresponding to the animation-refreshing request;
obtaining, from at least one received animation-refreshing request, at least one target animation-refreshing request in a time period from a current time to a last refreshing time, in response to the current time reaching a preset refreshing time; and
sending the at least one target animation-refreshing request to the processor, to cause the processor to perform animation refreshing corresponding to the at least one target animation-refreshing request.

2. The method of claim 1, wherein prior to receiving the animation-refreshing request of the animation, the method further comprises:
obtaining an image resource of the animation and storing the image resource into a local memory; and
the method further comprises:
controlling the processor to read a corresponding image resource from the local memory according to the at least one target animation-refreshing request, and perform the animation refreshing according to the corresponding image resource.

3. The method of claim 1, wherein prior to sending the at least one target animation-refreshing request to the processor, the method further comprises:
determining a quantity of the at least one target animation-refreshing request in the time period from the current time to the last refreshing time.

4. The method of claim 3, wherein sending the at least one target animation-refreshing request to the processor comprises:
continuing to obtain a target animation-refreshing request from the at least one received animation-refreshing request based on a determination that the quantity is less than a quantity threshold, until a quantity of target animation-refreshing requests obtained equals to the quantity threshold; and
sending the target animation-refreshing requests obtained to the processor.

5. The method of claim 3, wherein sending the at least one target animation-refreshing request to the processor comprises:
obtaining a priority of each of the at least one target animation-refreshing request based on a determination that the quantity is greater than a quantity threshold;
obtaining, from the at least one target animation-refreshing request in the time period from the current time to the last refreshing time, target animation-refreshing requests of the quantity threshold according to the priority; and
sending the target animation-refreshing requests of the quantity threshold to the processor.

6. The method of claim 3, wherein sending the at least one target animation-refreshing request to the processor comprises:
based on a determination that the quantity is greater than a quantity threshold, updating the preset refreshing time to an updated preset refreshing time, such that a quantity of target animation-refreshing requests in a time period from the updated preset refreshing time to the last refreshing time obtained from the at least one received animation-refreshing request equals to the quantity threshold;
sending the target animation-refreshing requests to the processor in response to the current time reaching the updated preset refreshing time.

7. The method of claim 1, wherein prior to obtaining, from the at least one received animation-refreshing request, the at least one target animation-refreshing request in the time period from the current time to the last refreshing time, in response to the current time reaching the preset refreshing time, the method further comprises:
obtaining a remaining power of a terminal comprising the processor; and
obtaining, according to the remaining power, the preset refreshing time corresponding to the remaining power from a correspondence between remaining powers and preset refreshing times.

8. The method of claim 1, wherein after sending the at least one target animation-refreshing request to the processor, the method further comprises:
removing the at least one target animation-refreshing request from the at least one received animation-refreshing request.

9. A computer device, comprising:
at least one processor comprising a first processor and a second processor; and
a memory storing a computer program, the computer program being executed by the first processor to cause the first processor to:
receive an animation-refreshing request of an animation, the animation-refreshing request instructing the second processor to perform animation refreshing corresponding to the animation-refreshing request;
obtain, from at least one received animation-refreshing request, at least one target animation-refreshing request in a time period from a current time to a last refreshing time, in response to the current time reaching a preset refreshing time; and
send the at least one target animation-refreshing request to the second processor, to cause the second processor to perform animation refreshing corresponding to the at least one target animation-refreshing request.

10. The computer device of claim 9, wherein the computer program is executed by the first processor to cause the first processor to:
obtain an image resource of the animation and store the image resource into a local memory; and
control the second processor to read a corresponding image resource from the local memory according to the at least one target animation-refreshing request, and perform the animation refreshing according to the corresponding image resource.

11. The computer device of claim 9, wherein the computer program is executed by the first processor to further cause the first processor to:
determine a quantity of the at least one target animation-refreshing request in the time period from the current time to the last refreshing time.

12. The computer device of claim 11, wherein the computer program executed by the first processor to send the at least one target animation-refreshing request to the second processor is executed by the first processor to:
continue to obtain a target animation-refreshing request from the at least one received animation-refreshing request based on a determination that the quantity is less than a quantity threshold, until a quantity of target animation-refreshing requests obtained equals to the quantity threshold; and
send the target animation-refreshing requests obtained to the second processor.

13. The computer device of claim 11, wherein the computer program executed by the first processor to send the at least one target animation-refreshing request to the second processor is executed by the first processor to:
obtain a priority of each of the at least one target animation-refreshing request based on a determination that the quantity is greater than a quantity threshold;
obtain, from the at least one target animation-refreshing request in the time period from the current time to the last refreshing time, target animation-refreshing requests of the quantity threshold according to the priority; and
send the target animation-refreshing requests of the quantity threshold to the second processor.

14. The computer device of claim 11, wherein the computer program executed by the first processor to send the at least one target animation-refreshing request to the second processor is executed by the first processor to:
based on a determination that the quantity is greater than a quantity threshold, update the preset refreshing time to an updated preset refreshing time, such that a quantity of target animation-refreshing requests in a time period from the updated preset refreshing time to the last refreshing time obtained from the at least one received animation-refreshing request equals to the quantity threshold;
send the target animation-refreshing requests to the second processor in response to the current time reaching the updated preset refreshing time.

15. The computer device of claim 9, wherein the computer program is executed by the first processor to further cause the first processor to:
obtain a remaining power of the computer device; and
obtain, according to the remaining power, the preset refreshing time corresponding to the remaining power from a correspondence between remaining powers and preset refreshing times.

16. The computer device of claim 9, wherein the computer program is executed by the first processor to further cause the first processor to:
remove the at least one target animation-refreshing request from the at least one received animation-refreshing request.

17. A non-transitory computer-readable storage medium storing a computer program, the computer program being executed by a first processor to cause the first processor to:
receive an animation-refreshing request of an animation, the animation-refreshing request instructing a second processor to perform animation refreshing corresponding to the animation-refreshing request;
obtain, from at least one received animation-refreshing request, at least one target animation-refreshing request in a time period from a current time to a last refreshing time, in response to the current time reaches a preset refreshing time; and
send the at least one target animation-refreshing request to the second processor, to cause the second processor to perform animation refreshing corresponding to the at least one target animation-refreshing request.

18. The non-transitory computer-readable storage medium of claim 17, wherein the computer program is executed by the first processor to further cause the first processor to:
obtain an image resource of the animation and store the image resource into a local memory; and
control the second processor to read a corresponding image resource from the local memory according to the at least one target animation-refreshing request, and perform the animation refreshing according to the corresponding image resource.

19. The non-transitory computer-readable storage medium of claim 17, wherein the computer program is executed by the first processor to further cause the first processor to:
determine a quantity of the at least one target animation-refreshing request in the time period from the current time to the last refreshing time.

20. The non-transitory computer-readable storage medium of claim 19, wherein the computer program executed by the first processor to send the at least one target animation-refreshing request to the second processor is executed by the first processor to:
obtain a priority of each of the at least one target animation-refreshing request based on a determination that the quantity is greater than a quantity threshold;
obtain, from the at least one target animation-refreshing request in the time period from the current time to the last refreshing time, target animation-refreshing requests of the quantity threshold according to the priority; and
send the target animation-refreshing requests of the quantity threshold to the second processor.
